(19) United States
(12) Patent Application Publication
(10) Pub. No.: US 2026/0291566 A1
(43) Pub. Date: Sep. 24, 2026

(54) SUBBAND-BASED ANALOG BEAMFORMING FOR UPLINK

(71) Applicant: InterDigital Patent Holdings, Inc., Wilmington, DE (US)

(72) Inventors: Loic Canonne-Velasquez, Dorval (CA); Afshin Haghighat, Ile-Bizard (CA); Jonghyun Park, Syosset, NY (US); Virgil Comsa, Montreal (CA); Mohammad Irfan, Chateauguay (CA); Moon Il Lee, Melville, NY (US); Dylan Watts, Montreal (CA); Paul Marinier, Brossard (CA); Tao Deng, New York, NY (US); Omid Saatlou, Montreal (CA)

(73) Assignee: InterDigital Patent Holdings, Inc., Wilmington, DE (US)

(21) Appl. No.: 19/088,306

(22) Filed: Mar. 24, 2025

(51) Int. Cl. H04B 7/06; H04W 72/21

(52) U.S. Cl. CPC H04B 7/0617; H04B 7/06966; H04W 72/21

(57) ABSTRACT

Example procedures for subband (SB)-based analog beamforming for uplink (UL) transmission are disclosed herein. A wireless transmit/receive unit (WTRU) may receive, from a base station, configuration information indicating sounding reference signal (SRS) resource information including a set of subbands, a set of simultaneous beams, and correspondence information indicating correspondence between the set of simultaneous beams and the set of subbands. The WTRU may transmit at least one SRS using the set of subbands and the set of simultaneous beams in accordance with the indicated correspondence information. The WTRU may receive, from the base station, a grant indicating a plurality of resource block groups (RBGs). The WTRU may determine a mapping between the set of simultaneous beams and the plurality of RBGs and transmit, to the base station, an uplink signal using the indicated RBGs and the set of simultaneous beams in accordance with the mapping.

### BACKGROUND

Fifth Generation (5G) New Radio (NR) uplink transmission assumes that a wireless transmit/receive unit (WTRU) (e.g., User Equipment, UE) can generate a single analog beam at a time on the uplink using a phased array. Analog beamforming may use, for example, True Time Delays (TTDs) as opposed to only using phase offsets. TTDs allow the generation of a frequency-dependent analog beam, which may be considered equivalent to multiple analog beam directions generated at the same time, thus expanding functionality of WTRUs to supporting multiple simultaneous beams in the uplink.

### SUMMARY

Example procedures for subband (SB)-based analog beamforming for uplink (UL) transmission are disclosed herein. A wireless transmit/receive unit (WTRU) may receive, from a base station, configuration information indicating sounding reference signal (SRS) resource information including a set of subbands, a set of simultaneous beams, and correspondence information indicating correspondence between the set of simultaneous beams and the set of subbands. A number of beams in the set of simultaneous beams may be less than or equal to a maximum number of simultaneous beams supported by the WTRU. The WTRU may transmit, to the base station, at least one SRS using the set of subbands and the set of simultaneous beams in accordance with the indicated correspondence information. The WTRU may receive, from the base station, a grant indicating a plurality of resource block groups (RBGs). The WTRU may determine a mapping between the set of simultaneous beams and the plurality of RBGs. The WTRU may transmit, to the base station, an uplink signal using the indicated RBGs and the set of simultaneous beams in accordance with the mapping.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a resource diagram illustrating an example frequency correspondence of multiple simultaneous beams in the uplink;

FIG. 3 is a field format diagram illustrating an example DCI field of a DCI for unified TCI-state indications;

FIG. 4 is a resource diagram illustrating an example resource-level beam association;

FIG. 5 is a resource diagram illustrating an example set-level beam association;

FIG. 6 is a signaling diagram illustrating an example SB-based beamforming procedure using SB-to-RBG association;

FIG. 7 is a flow diagram illustrating an example uplink transmission procedure with SB-based beamforming SB-to-RBG association; and

FIG. 8 is a flow diagram illustrating another example uplink transmission procedure with SB-based beamforming SB-to-RBG association.

### DETAILED DESCRIPTION

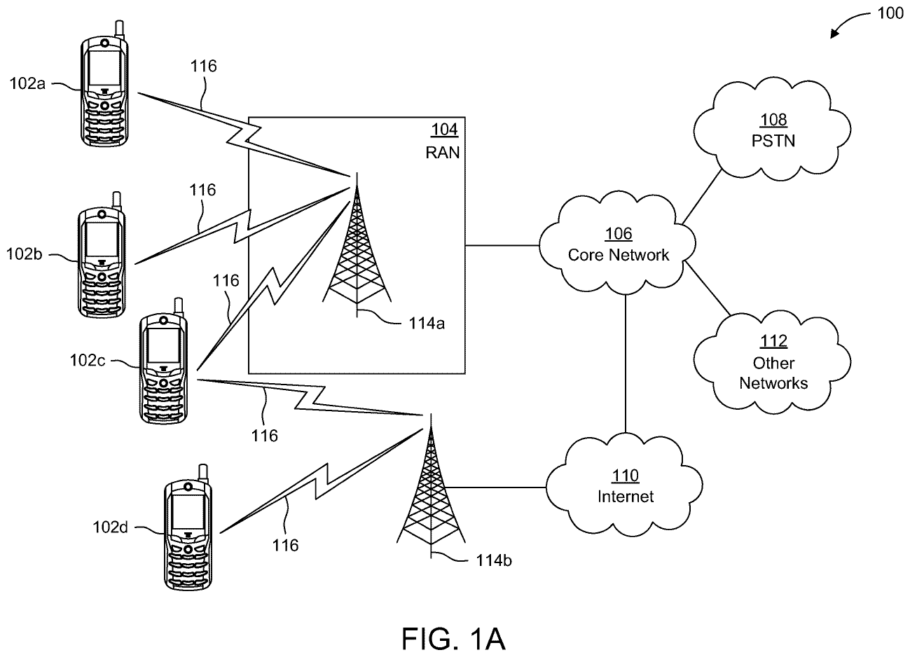

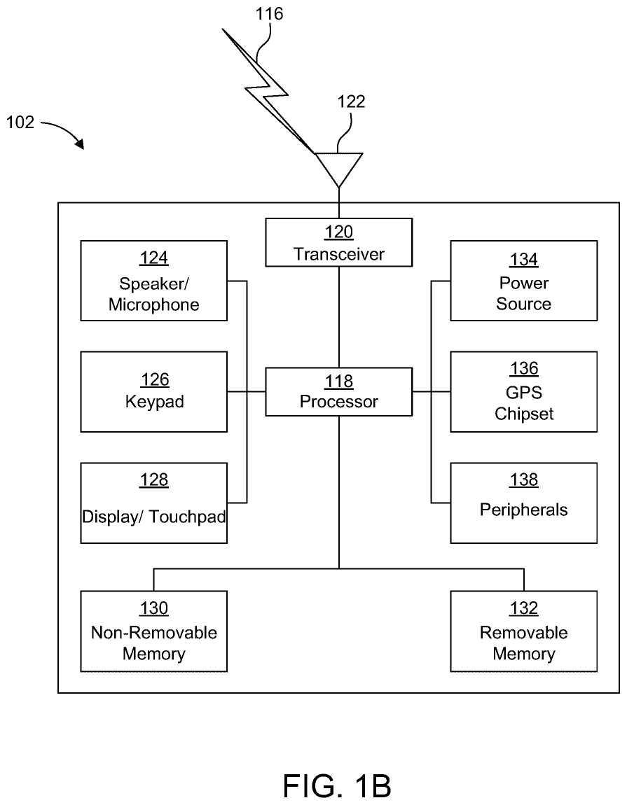

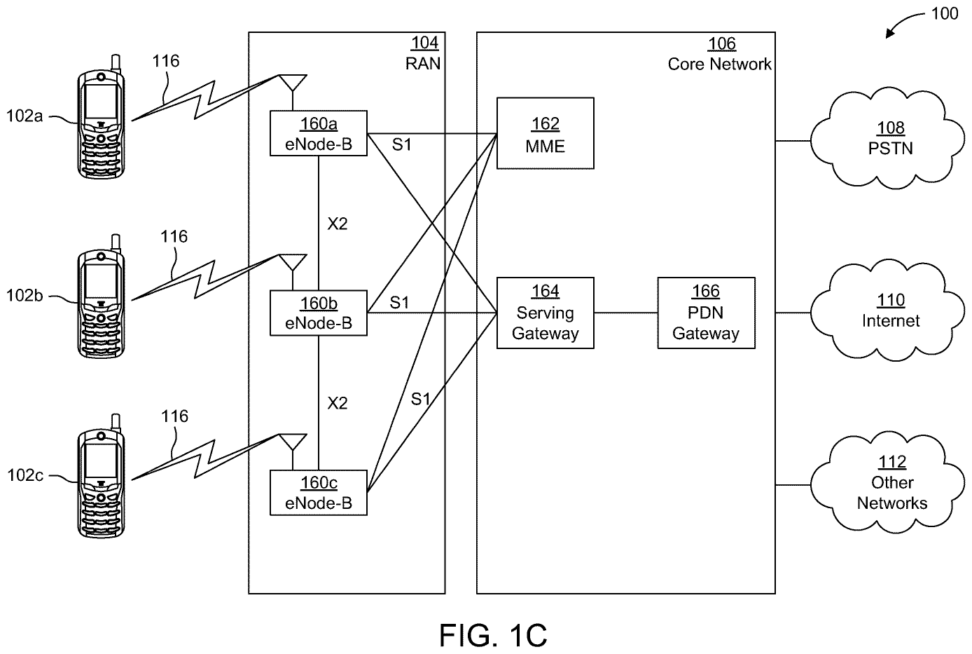

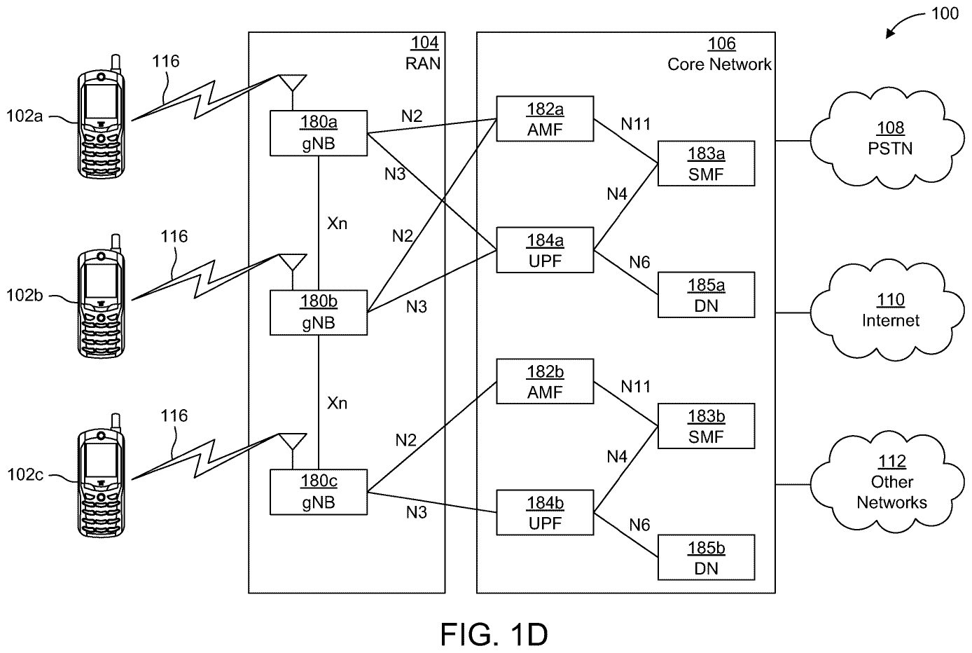

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

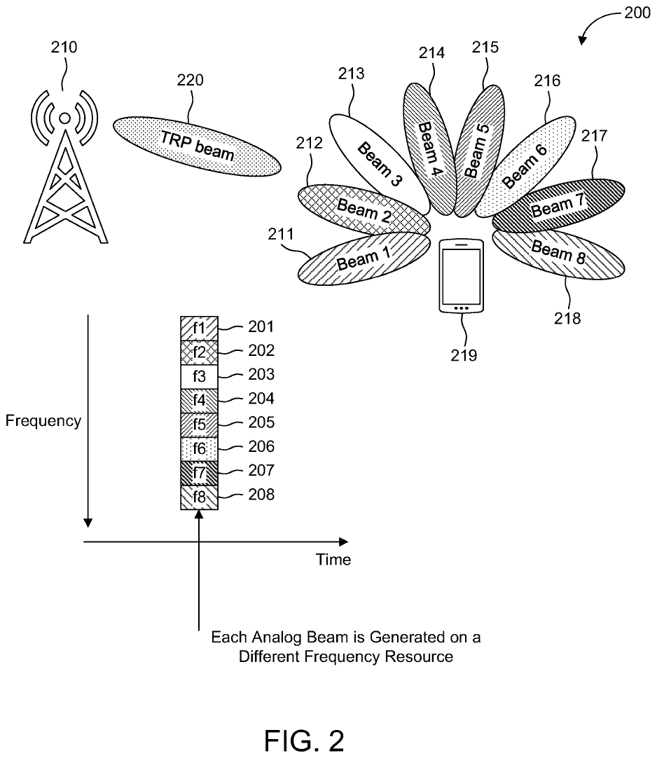

Fifth Generation (5G) New Radio (NR) uplink transmission assumes that a wireless transmit/receive unit (WTRU) (e.g., User Equipment, UE) can generate a single analog beam at a time on the uplink using a phased array. Analog beamforming may use, for example, True Time Delays (TTDs) as opposed to only using phase offsets. TTDs allow the generation of a frequency-dependent analog beam, which may be considered equivalent to multiple analog beam directions generated at the same time, thus expanding functionality of WTRUs to supporting multiple simultaneous beams in the uplink. FIG. 2 is a resource diagram illustrating an example frequency correspondence 200 of multiple simultaneous beams in the uplink. In this example, a WTRU 219 may generates eight different beam directions 211-218 at the same time, and each beam direction is transmitted on a single corresponding frequency resource 201-208 (e.g., eight corresponding frequency subbands). The network node 210 may receive all different beam directions 211-218 at once using a single receive (transmission-reception point, TRP) beam 220. This type of scheme is beneficial to reduce the latency of analog beam sounding by allowing multiple analog beams to be sounded in a single symbol (e.g., eight beams in one symbol instead of eight beams over eight symbols).

Frequency-selective uplink (UL) beamforming is not supported in 5G NR (e.g., for physical uplink shared channel (PUSCH)). Only wideband analog and digital beamforming is supported. In one symbol, UL PHY channels can be transmitted with only one UL transmission configuration indicator (TCI) and/or one Transmitted precoding matrix indicator (TPMI) (i.e., single antenna panel). However, the channel may be frequency-selective, and wider bandwidths exhibit higher variations over the allocated frequencies. 6^{th} Generation (6G) wireless communication systems will likely use wider bandwidths in the UL to support higher throughputs. If an implementation with multiple beams per slot is used, a WTRU can generate multiple different analog beams simultaneously over different frequency resources. However, there is no procedure to allow the WTRU to transmit a frequency-selective PUSCH with multiple analog beams. Thus, procedures and solutions for a WTRU to determine the analog beams and transmission parameters on a frequency-selective resource assignment are disclosed herein.

In an example procedure, subband-based analog beamformed PUSCH transmission may use a subband (SB)-to-resource block group (RBG) mapping. A WTRU may signal the WTRU's capability for subband-based (SBB) transmission including the maximum number of simultaneous beams supported by the WTRU, Kₘₐₓ. The WTRU may be configured with (e.g., receives configuration information indicating) a first SRS resource with up to Kₘₐₓ beams, and a configuration of subbands (SBs) where each subband (SB) is associated to one of the beams. The WTRU may be triggered (e.g., periodically/semi-persistently/aperiodically) to transmit, and may transmit SRS signals on the first SRS resource using the configured beams on the subbands to assist the network in determining one or more subsets (e.g., S subsets, S>=1) of Kᵢ beams (i=1 to S) (e.g., the network may determine the subset of beams based on channel quality). For each subset i, the Kᵢ beams may be identified with respect to the beams the WTRU used to transmit on the first SRS resource.

The WTRU may be configured with (e.g., receives configuration information indicating) an SRS resource (SRS resource i) for each subset i of the S subsets, the associated Kᵢ beams, and a configuration of SBᵢ subbands in SRS resource i where each subband is associated to one of the Kᵢ beams. Each SRS resource i is associated with an SRS resource index (SRI) value. SBᵢ may be less than, equal to, or greater than Kᵢ. For at least one (e.g., each) SRS resource i, the WTRU may be triggered (e.g., periodically/semi-persistently/aperiodically) to transmit, and transmits, on the SRS resource i using the associated Kᵢ beams on the associated subbands. The WTRU may receive scheduling information (e.g., an UL grant from the NW) for an uplink (e.g., PUSCH) transmission, where the scheduling information may indicate an SRI value that identifies an SRS resource i and a resource allocation including one or more (e.g., N_{RBG}) PUSCH resource block groups (RBGs). The grant downlink control information (DCI) may include a Frequency Domain Resource Allocation (FDRA) that indicates the Resource Block Groups (RBGs) assigned to transmit the PUSCH, and the SRS resource index i.

The WTRU may determine an association between the subbands in SRS resource i and the allocated PUSCH RBGs, for example RBG indices, (SB-to-RBG mapping) and/or a mapping between the beams associated with SRS resource i and the RBGs using one or more of the following example mappings. In an example mapping, each SRS subband (SB) of the SBᵢ SBs that overlaps an RBG, matches an RBG or a set of RBGs (in frequency). Each SB may be mapped to the RBG(s) it matches in frequency (or is mapped to no RBGs in the case of no overlap). If a match is not exact, the SB that overlaps an RBG the most (e.g., the most subcarriers), may be mapped to the RBG. In another example mapping, the WTRU is configured with an explicit mapping of all or a subset of the SBᵢ SBs or Kᵢ beams to N_{RBG} (e.g., SRS SB 1 or beam 1 maps to FDRA RBGs 1-4, etc.). In another example mapping, the WTRU may be configured with a rule that is a function of the SBᵢ SBs or the Kᵢ beams and N_{RBG} (e.g., Kᵢ=2 beams and 8 RBGs—WTRU applies the first beam over the first half of the RBGs, and the second beam over the next half of RBGs). In another example mapping, the WTRU may dynamically receive the mapping (e.g., SB to RBG or beam to RBG) in a DCI (e.g., the grant DCI) or a medium access control (MAC) control element (MAC-CE). The network (NW) may dynamically change the number of RBGs associated per SB or beam. Once the WTRU determines an SB-to-RBG mapping, the WTRU may then map the beam associated to each mapped SB to the RBGs mapped to the SB. The WTRU may transmit the PUSCH over the allocated RBGs with the determined beam for each RBG and power control per RBG as a function of the SB-to-RBG mapping (or beam-to-RBG mapping).

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’. A WTRU may transmit or receive a physical channel or reference signal according to at least one spatial domain filter. The term “beam” may be used to refer to a spatial domain filter. The beam may interchangeably be used with an analog beamformer, a digital beamformer, an analog precoder, or a digital precoder.

The WTRU may transmit a physical channel or signal using the same spatial domain filter as the spatial domain filter used for receiving a reference signal (RS) (e.g., channel state information RS, CSI-RS) or a synchronization signal (SS) block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) signaling or signaled by MAC CE or DCI. For example, a WTRU may implicitly transmit PUSCH and demodulation reference signal (DM-RS) of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and the physical channel's respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

Example quasi-colocation (QCL) assumptions and/or configurations may be used. A WTRU may receive transmit configuration indication (TCI) related configuration(s), for example comprising a plurality of TCI-states (e.g., an RRC-configured pool of TCI-states (e.g., as unified TCI framework), ‘TCI-State’ IE, ‘TCI-UL-State’ information element (IE), ‘spatialRelationInfo’ IE, etc.). A TCI-state of the plurality of TCI-states may be associated (comprised) with at least one of: QCL-info #1, QCL-info #2, additionalPCI, pathloss RS identity (PLRS-ID), uplink physical cell (UL-PC), Timing Advance Group (TAG)-ID, where QCL-info #1 (or QCL-info #2) may comprise a cell identity (cell-ID) (e.g., serving-cell index), a bandwidth part identity (BWP-ID_, a RS (e.g., CSI-RS, synchronization signal block index (SSB-index)), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop (CL)-index, power offset, etc.) may be for determining an uplink power for an UL transmission associated with the TCI-state. In an example, the additionalPCI may be a physical cell-ID (PCID) of a neighboring (surrounding) cell that the RS (associated with the TCI-state) (e.g., SSB-index (or CSI-RS) may be transmitted from, for example, as an inter-cell beam or RS reference). In an example, the WTRU may apply a timing advance value (e.g., based on received timing advance command (TAC)(s)) in association with the TAG-ID (e.g., of multiple TAG-IDs being configured) to a scheduled UL transmission. typeA may represent {Doppler shift, Doppler spread, average delay, delay spread}, typeB may represent {Doppler shift, Doppler spread}, typeC may represent {Doppler shift, average delay}, and typeD may represent {Spatial Rx parameter}.

When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, Spatial Rx parameter) based on the indicated QCL-type, and apply the at least one parameter for transmission or reception of the physical channel or signal.

A unified TCI (UTCI) (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., WTRU assumption) for determining QCL and/or spatial filter. In an example, a WTRU may receive (e.g., from a gNB) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all (or subset of) CORESETs in a component carrier (CC). In an example, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL transmission (TX) spatial filter(s) at least for dynamic-grant/configured-grant based PUSCH and all (or subset of) dedicated PUCCH resources in a CC.

The WTRU may be configured with a first mode for unified TCI (e.g., SeparateDLULTCI mode, a parameter of ‘unifiedTC/-State Type’ set to ‘separate’) where an indicated unified TCI (e.g., the first unified TCI or the second unified TCI) may be applicable for either downlink (e.g., based on the first unified TCI) or uplink (e.g., based on the second unified TCI). In an example, a WTRU may receive (e.g., from a base station (BS), a gNB, a TRP, etc.) an indication of a second unified TCI to be used/applied commonly for a PDCCH, a PDSCH, a PUCCH, and a PUSCH (and a DL RS and/or a UL RS). The WTRU may be configured with a second mode for unified TCI (e.g., JointTCI mode, a parameter of ‘unifiedTCI-State Type’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a Coreset Pool identity (e.g., CORESETPoolIndex, a TRP indicator, and/or the like).

Herein, unified TCI may be interchangeably used with one or more of unified TCI-states, unified TCI instance, TCI, and TCI-state, but still consistent with this invention.

A WTRU may be configured with a plurality of transmission configuration indicator (TCI) states, for example unified TCI (UTCI) states, each applicable for multiple channel(s)/signal(s). The multiple channel(s)/signal(s) may be configured to the WTRU (or pre-determined or defined), for example in the form of a list, by higher-layer signaling (e.g., RRC and/or MAC-CE) which may comprise any one or more of following (e.g., as a combination): one or more control resource sets (CORESETs); one or more PDCCH candidates; one or more search spaces; one or more PDSCHs (e.g., PDSCH occasions/configurations/instances, etc.); one or more RSs (e.g., CSI-RSs, DMRSs, synchronization signal block (SSB) indexes, positioning reference signals (PRSs), phase tracking reference signals (PTRSs), and/or sounding reference signals (SRSs)); one or more PUSCHs (e.g., PUSCH occasions/configurations/instances, etc.); one or more PUCCH resources (e.g., PUCCH resource sets/groups); and/or one or more physical random access channel (PRACH) occasions/resources/RSs.

The plurality of TCI states may be configured via RRC signaling (e.g., and/or via a MAC-CE signaling, indication or activation). The WTRU may receive, for example via the MAC-CE or a separate signaling, an information content comprising mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

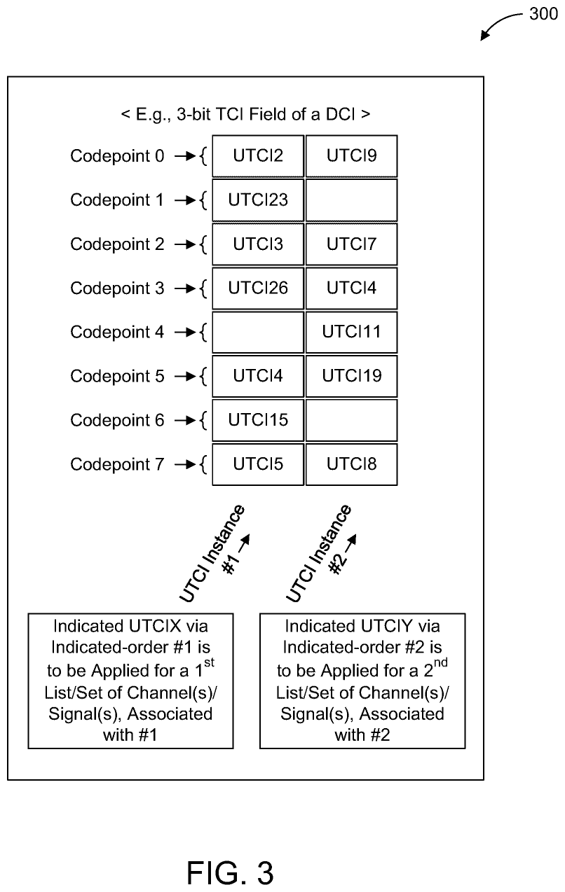

FIG. 3 is a field format diagram illustrating an example DCI field 300 (e.g., TCI field) of a DCI for unified TCI-state indications. A WTRU may receive (e.g., via a MAC-CE signaling) the mapping between a codepoint (of the DCI field) and one or more TCI states, as illustrated in FIG. 3. For DCI field 300, Codepoint 2 is mapped to {UTCI3, UTCI7}, where the WTRU may apply at least one of {UTCI3, UTCI7} to the multiple channel(s)/signal(s), for example based on a list of the multiple channel(s)/signal(s) configurable by a higher-layer signaling from a gNB. In an example, the list of the multiple channel(s)/signal(s) may be given per UTCI instance (e.g., TCI-state group, a group of TCI-states, a set of activated TCI-states), where the UTCI instance may correspond to each column of the mapping table, between a codepoint and the one or more TCI states.

Herein, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Herein, Multi-TRP may be interchangeably used with one or more of MTRP, M-TRP, and multiple TRPs, but still consistent with this invention.

A WTRU may be configured with (or may receive configuration of) one or more TRPs to which the WTRU may transmit and/or from which the WTRU may receive. The WTRU may be configured with one or more TRPs for one or more cells. A cell may be a serving cell, secondary cell. A WTRU may be configured with at least one RS for the purpose of channel measurement. This RS may be denoted as a Channel Measurement Resource (CMR) and may comprise a CSI-RS, SSB, or another downlink RS transmitted from the TRP to a WTRU. A CMR may be configured or associated with a TCI state. A WTRU may be configured with a CMR group where CMRs transmitted from the same TRP may be configured. Each group may be identified by a CMR group index (e.g. group 1). A WTRU may be configured with one CMR group per TRP, and the WTRU may receive a linkage between one CMR group index and another CMR group index, or between one RS index from one CMR group and another RS index from another group. A WTRU may be configured with (or receive configuration of) one or more pathloss (PL) reference groups (e.g., sets) and/or one or more SRS groups, SRS resource indicator (SRI) or SRS resource sets.

A pathloss (PL) reference group may correspond to or may be associated with a TRP. A PL reference group may include, identify, correspond to or be associated with one or more TCI states, SRIs, reference signal sets (e.g. CSI-RS set, SRI sets), CORESET index, and or reference signals (e.g. CSI-RS, SSB). A WTRU may receive a configuration (e.g., any configuration described herein). The configuration may be received from a gNB or TRP. For example, the WTRU may receive configuration of one or more TRPs, one or more PL reference groups and/or one or more SRI sets. A WTRU may implicitly determine an association between a RS set/group and a TRP. For example, if the WTRU is configured with two SRS resource sets, then the WTRU may determine to transmit to TRP1 with SRS in the first resource set, and to TRP2 with SRS in the second resource set. The configuration may be via RRC signaling.

In the examples and embodiments described herein, TRP, PL reference group, SRI group, and SRI set may be used interchangeably. The terms set and group may be used interchangeably herein.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as layer 1 reference signal received power (L1-RSRP), layer 1 signal-to-interference-plus-noise ratio (L1-SINR) taken from SSB or CSI-RS (e.g. CSI-RS resource index-RSRP (cri-RSRP), cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

Herein, a property of a grant or assignment may consist of any one or more of the following: a frequency allocation; an aspect of time allocation, such as a duration; a priority; a modulation and coding scheme (MCS); a transport block size; a number of spatial layers; a number of transport blocks (TBs); A TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

In the following, an indication by DCI may consist of at least one or more of the following: an explicit indication by a DCI field or by RNTI used to mask CRC of the PDCCH; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC. Herein, a signal may be used interchangeably with one or more of following: Sounding reference signal (SRS); Channel state information-reference signal (CSI-RS); Demodulation reference signal (DM-RS); Phase tracking reference signal (PT-RS); and/or Synchronization signal block (SSB). Herein, a channel may be used interchangeably with one or more of following: Physical downlink control channel (PDCCH); Physical downlink shared channel (PDSCH); Physical uplink control channel (PUCCH); Physical uplink shared channel (PUSCH); and/or Physical random access channel (PRACH).

Herein, downlink reception may be used interchangeably with Rx occasion, PDCCH, PDSCH, SSB reception, but still consistent with this invention. Herein, uplink transmission may be used interchangeably with Tx occasion, PUCCH, PUSCH, PRACH, SRS transmission, but still consistent with this invention. Herein, RS may be used interchangeably with one or more of RS resource, RS resource set, RS port and RS port group, but still consistent with this invention. Herein, RS may be used interchangeably with one or more of SSB, CSI-RS, SRS and DM-RS, but still consistent with this invention. Herein, time instance may be interchangeably used with slot, symbol, subframe, but still consistent with this invention. Herein, UTCI may be interchangeably used with TCI, UTCI state, TCI state, but still consistent with this invention.

Example procedures for configuration of SRS resources with SB-level analog beamforming are disclosed herein. According to an example procedure, a WTRU may signal the WTRU's capability for subband-based (SBB) transmission including the maximum number of simultaneous beams supported by the WTRU, Kₘₐₓ. The WTRU may be configured with (e.g., receives configuration information indicating) a first SRS resource with up to Kₘₐₓ beams, and a configuration of subbands where each subband is associated to one of the beams. The WTRU may be triggered (e.g., periodically/semi-persistently/aperiodically) to transmit, and transmits, on the first SRS resource using the configured beams on the subbands to assist the network in determining one or more subsets (S subsets, S>=1) of Kᵢ beams (i=1 to S) (e.g., based on channel quality). For each subset i, the Kᵢ beams may be identified with respect to the beams the WTRU used to transmit on the first SRS resource. The WTRU may be configured with (e.g., receives configuration information indicating) an SRS resource (SRS resource i) for each subset i of the S subsets, the associated Kᵢ beams, and a configuration of SBᵢ subbands in SRS resource i where each subband is associated to one of the Kᵢ beams. Each SRS resource i is associated with an SRS resource index (SRI) value. SBᵢ may be less than, equal to, or greater than Kᵢ. For at least one (e.g., each) SRS resource i, the WTRU may be triggered (e.g., periodically/semi-persistently/aperiodically) to transmit, and transmits, on the SRS resource i using the associated Kᵢ beams on the associated subbands.

In a multi-beam-based system, different beams may be associated to different frequency resources of a same resource in time. For example, in an OFDM-based transmission, different subbands where each subbands is identified as a contiguous group of subcarriers of resource blocks, may be associated with a different beam. For uplink channel sounding SRS transmission, a WTRU may transmit SRSs using multiple SRS resources where each resource is associated with a different beam. For example, in the case of uplink beam selection, a WTRU may transmit multiple single port SRSs, while in case of uplink CSI estimation, a WTRU may transmit multiple P-port SRSs. An SRS configuration may include configuration of one or more SRS resource sets where each SRS resource set may include one or more SRS resources. In a transmission, SRS configuration may be done, based one or more of the following types: (SRS) resource-level beam association; and/or (SRS resource) set-level beam association.

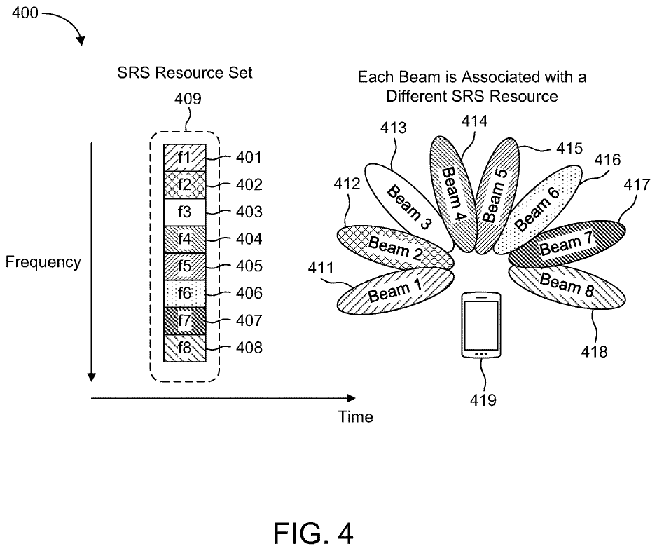

FIG. 4 is a resource diagram illustrating an example resource-level beam association 400 (e.g., for SRS resource). In this type of resource-level beam association 400, an SRS resource set 409 containing one or more of SRS resources 401-408 may be defined, where each of up to Kₘₐₓ beams (e.g., Kₘₐₓ=8) may be associated with one or more SRS resources 401-408. In this example, a WTRU 419 may generates eight different beams (beam directions) 411-418 at the same time, and each beam 411-418 is transmitted on a single corresponding frequency resource 401-408 (e.g., eight corresponding frequency subbands). The association of beams 411-418 to SRS resources 401-408 may be indicated using SRS resource identifiers (IDs), where each SRS resource 401-408 may be configured with a different reference signal as a reference for the spatial information. In an example, each SRS resource 401-408 may be associated with a set of beam indices, where the association of beam indices to different reference signals may be configured and updated based on at least one of semi-static or dynamic signaling.

In an example, when a WTRU is configured to operate with Kₘₐₓ simultaneous beams, one or more of the following may be assumed: all SRS resources within a configured SRS resource set may be configured with a same configuration for the number of SRS ports; all SRS resources within a configured SRS resource set may be configured with a same configuration for transmission comb (e.g., for at least one of: comb offset or cyclic shift values); and/or all SRS resources within a configured SRS resource set may be configured with a same transmission configuration for resource mapping (e.g., at least for one of: symbol location of the SRS resource within a slot, number of OFDM symbols per SRS resource, and/or starting position of SRS resource within the slot and the repetition factor).

In an example, a WTRU may receive an SRS resource set configuration with usage “simultaneous beam per time resource”, where the configuration may include one or more of the following: at least one configuration for the number of SRS ports, applicable to all SRS resources in the SRS resource set; at least one configuration for transmission comb definition (e.g., for at least one of: comb offset or cyclic shift values, applicable to all SRS resources in the SRS resource set); and/or at least one configuration for definition of resource mapping (e.g., at least for one of: symbol location of the SRS resource within a slot, number of OFDM symbols per SRS resource, starting position of SRS resource within the slot and the repetition factor, and/or applicable to all SRS resources in the SRS resource set).

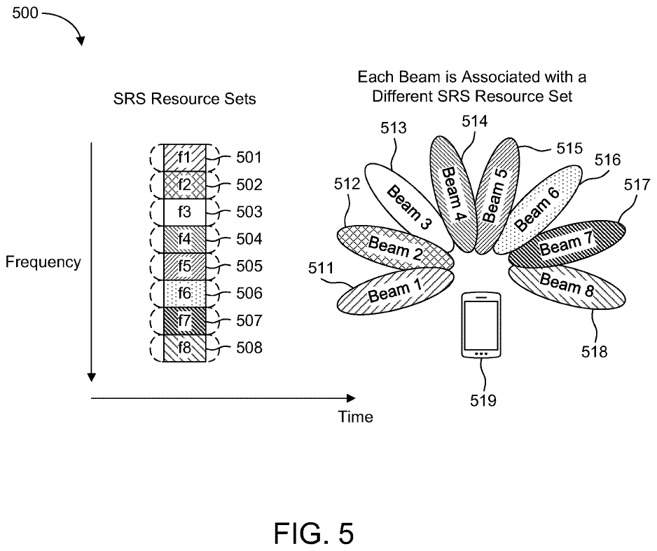

FIG. 5 is a resource diagram illustrating an example set-level beam association 500 (e.g., for a SRS resource). In this type of set-level beam association 500, each SRS resource set 501-508 containing one or more of SRS resources is associated to one of up to Kₘₐₓ beams (e.g., Kₘₐₓ=8). The set-level beam association 500 of beams 511-518 to SRS resource 501-508 may be indicated using SRS resource set identifiers (IDs), where each SRS resource set 501-508 may be configured with a different reference signal as a reference for the spatial information. In an example, each SRS resource set 501-508 may be associated with a set of beam indices, where the association of beam indices to different reference signals may be configured and updated based on at least one of semi-static or dynamic signaling.

When WTRU is configured to operate with Kₘₐₓ simultaneous beams, one or more of the following may be expected, An SRS resource set may be configured with at least one beam information, e.g., spatial relation information, that may be applicable to all SRS resources within the configured SRS resource set.

Example WTRU procedures support frequency-dependent analog beamforming. In an example, A WTRU may signal or send (e.g., using an uplink channel like PUCCH or on a MAC-CE) the WTRU's capability of frequency-dependent beamforming to the gNB. WTRU may indicate capability and/or support for one or more aspects of frequency-dependent analog beamforming. In an example, the WTRU may indicate a single capability to indicate support for all aspects of frequency-dependent analog beamforming. In another example, the WTRU may report support for an/each aspect of frequency-dependent analog beamforming. The capabilities, or the capabilities indication may include any one or more of the following example information.

As example information, the WTRU may declare to the gNB or sends indications that the WTRU is capable of performing frequency-dependent analog beamforming. As example information, the WTRU may indicate the frequency granularity at which it can perform frequency-dependent analog beamforming. For example, a WTRU may signal to the gNB that it has the ability (e.g., the hardware capability) to generate an analog beam at each resource block (RBs), each subband (SB), each bandwidth part (BWP), or a subset of RBs, subset of SBs, or subset of BWPs, etc., at a given time-instance (e.g., at a given symbol). As example information, the WTRU may indicate a subcarrier spacing specific frequency-dependent analog beamforming capabilities. For example, the WTRU may declare that the WTRU can support SB-level analog beamforming at a first subcarrier spacing value and RB-level analog beamforming at a second subcarrier spacing value.

As example information, the WTRU may declare a maximum number of simultaneous (e.g., at the same time instance) frequency-dependent analog beams (e.g., Kₘₐₓ) supported by the WTRU, where the maximum number of simultaneous analog beams may depend on one or more of the following: the carrier signal frequency (e.g., for a first carrier frequency f₁, Kₘₐₓ=4 and for a second carrier frequency f₂, Kₘₐₓ=8; and/or the subcarrier spacing (e.g., for a first subcarrier spacing value Kₘₐₓ=4 and for a second subcarrier spacing value Kₘₐₓ=8). As example information, the WTRU may declare a number of simultaneous (e.g., at the same time instance) frequency-dependent analog beams for fallback scenarios (e.g., K_{fallback} where K_{fallback}≤Kₘₐₓ) and where the maximum number of simultaneous fallback analog beams may depend on one or more of the following; the carrier signal frequency (e.g., for a first carrier frequency f₁, K_{fallback}=2 and for a second carrier frequency f₂, K_{fallback}=6); and/or the subcarrier spacing (e.g., for a first subcarrier spacing value K_{fallback}=3 and for a second subcarrier spacing value K_{fallback}=5).

A WTRU may report the capability of one or more of the above aspects of frequency-dependent analog beamforming, for example, a the WTRU capability transfer procedure. In another example, the WTRU may indicate capability and/or support via one or more of the following methods: random access (or use of one or more dedicated resources, use of random access preamble partitioning, such as for example a set of reserved preambles or random access occasions, RNTIs etc.); upon RRC connection establishment/resumption (e.g. Msg3 or Msg5); upon request from the network (e.g., upon reception of the capability enquiry message); and/or WTRU assistance information.

In an example, capability to support/perform/execute/initiate one or more aspects of frequency-dependent analog beamforming may be reliant/linked to one or more other configurations. For example, the network may assume that a WTRU is capable of one or more aspects of frequency-dependent analog beamforming based on, for example, an activation, state, and/or configuration (e.g., an association of SRS with Kₘₐₓ simultaneous analog beams).

In another example, the capability and/or support for initiation of one or more aspects of frequency-dependent analog beamforming may be reliant on one or more characteristics of the WTRU. Example characteristics of the WTRU may include any one or more of the following: WTRU speed; remaining WTRU power; WTRU processing ability; WTRU location (e.g. within a certain set of cells, using one of a set of specific beams, GPS location, etc.); and/or when a particular type of service is in use (e.g., related to one or more specific network slices or QCIs).

If a WTRU is configured for frequency-dependent analog beamforming, and an associated configuration is not present and/or active and/or the WTRU characteristics are not suitable, it may be assumed that the procedure is temporarily disabled (e.g., the WTRU may not initiate the procedure) or inactive. The WTRU may indicate (e.g., subject to configuration) to the network that frequency-dependent analog beamforming is temporarily inactive (e.g., via a MAC CE, UCI or RRC signalling). In an example, the WTRU may also report the reason for why the procedure is inactive (e.g., a joint configuration is disabled, or the WTRU characteristics are not suitable).

Example procedures for network (NW) support for frequency-dependent analog beamforming are disclosed herein. In an example, the network may indicate support for frequency-dependent analog beamforming. Support for frequency-dependent analog beamforming may be, for example, per cell, per PLMN, per frequency, per tracking area (TA) or RAN notification area (RNA). The indication may be, for example a flag and/or bit in system information which indicates support for frequency-dependent analog beamforming. In another solution, the network may indicate (e.g., within system information and/or via RRC configuration) a list of one or more cell(s) which support frequency-dependent analog beamforming.

In an example, the WTRU may only initiate frequency-dependent analog beamforming or one or more aspects of frequency-dependent analog beamforming subject to the network supporting the procedure. For example, the WTRU may only resume frequency-dependent analog beamforming upon return to RRC connected if the cell has indicated support for frequency-dependent analog beamforming.

A WTRU may be semi-statically or dynamically, (e.g., by Radio resource control (RRC) upon establishment/resumption of an RRC connection) (e.g., within the RRC Setup/Resume message) or upon handover to another cell (e.g., within a HO command/RRC reconfiguration message with a reconfiguration with sync) or at any time during an active RRC connection (e.g., RRC reconfiguration message without reconfiguration with sync), medium access control (MAC) control element (CE) (MAC-CE), and/or downlink control information (DCI)) configured and/or indicated (e.g., explicitly and/or implicitly configured and/or indicated a measurement resource set that includes one or more measurement resources, such as for example an SRS resource set that includes one or more SRS resources).

In an example, the WTRU may receive different information and/or components of a configuration for frequency-dependent analog beamforming via different signaling methods. For example, the WTRU may receive some dedicated configuration aspects via RRC signalling and some other configurations or information via system information If a WTRU is provided with a dedicated configuration/indication related to frequency-dependent analog beamforming, the WTRU may override other common configuration information (e.g., received via broadcast signalling) or may combine the dedicated configuration with one or more pieces of common configuration information. In another example, the WTRU may use the most recently received information in the configuration regardless of the signalling method.

The WTRU may receive one or more alternative configurations using one signalling method (E.g. via system information or dedicated RRC signalling). Using another type of signalling (e.g. via dedicated RRC signalling or MAC CE) the network may select or indication which of the one or more alternative configurations to apply. Any one or more of the following example configurations may apply. In an example configuration, each SRS resource in the SRS resource set may be associated with Kₘₐₓ number of analog beams, where the Kₘₐₓ number of analog beams may be simultaneous beams, e.g., Kₘₐₓ analog beams are transmitted or happens at the same time instance (e.g., in the same symbol). For example, Kₘₐₓ=5 and all 5 beams transmits or being scheduled to transmit at symbol 1. In another example configuration, one or more of the Kₘₐₓ analog beams may be simultaneous beams, and the remaining are non-simultaneous beam. For example, each SRS resource is associated with Kₘₐₓ=5 analog beams where 2 out of the 5 analog beams are transmitted at the same time instance (e.g., at symbol 1), and the remaining 3 beams are transmitted or scheduled for transmission at symbol 2. In another example configuration, the SRS resource set may have Kₘₐₓ number of SRS resources and each SRS resource in the SRS resource set is associated with a single analog beam.

In another example configuration, each of the analog beam may be associated with time-domain resources and frequency-domain resources. The time-domain resources and the frequency-domain resources for each of the analog beam may be explicitly or implicitly configured by the gNB. For example, an SRS resource may be associated with Kₘₐₓ=3 beams, where the peak of the first beam out of the 3 beams is at SB 1, 2, and 3. The peak of the second beam out of the 3 beams is at SBs 4, 5, and 6. The peak of the third beam is at SBs 7, 8, and 9 at a given time instance (e.g., at symbol 1). For example, an SRS resource may be associated with Kₘₐₓ=3 beams, where the peak of the first beam out of the 3 beams is at SB 1, 2, 3, 4 at symbol 1. The peak of the second beam out of the 3 beams is at SBs 4, 5, 6 at symbol 2. The peak of the third beam is at SBs 6, 7, 8, and 9 at symbol 3. The WTRU may receive one or more indications that indicates the SBs at a given time. For example, the WTRU may receive one or more indications that indicates the SBs at a symbol associated with a beam. For example, for beam 1, the WTRU receive the index of a SB (e.g., SB1=10) and a number of SBs (e.g., number subbands=3). Therefore, beam1 is associated with the 10^{th}, 11^{th}, and 12^{th} subband. In an example, Kₘₐₓ=4 and the total number of configured subbands are 24. The WTRU is also being configured that 6 subbands are associated with each beam and that all the 4 beams are simultaneously transmitted. For each beam, the WTRU may receive a bitmap of 4 bits. Each bit in the bitmap is associated with 6 subbands (e.g., with 6 consecutive subbands). The WTRU receives the following example bitmap, 1 0 1 0. The bitmap indicates that the first beam is associated with the first 6 subbands (i.e., subbands 1-6) and the third beam is associated with SBs 13-18 and that the beam 2 and beam 4 may be silent or may not be transmitted.

In another example configuration, the gNB may configure a time-domain transmission behavior for the simultaneous or non-simultaneous beams (e.g., an SRS resource is associated with Kₘₐₓ beams and each SRS resource in the SRS resource set has a time-domain transmission behavior). In an example, all SRS resources in the SRS resource set may have the same time-domain transmission behavior. For example, A WTRU may be configured or triggered to transmit an SRS resource using Kₘₐₓ beams where each beam is at a different SB and where transmission of the Kₘₐₓ beams may be periodic (P), semi-persistent (SP), or aperiodic (AP).

In an example, the receiver (e.g., the gNB) may receive the SRS resources, or the beams associated with the SRS resources at the configured SB indexes. Based on each beam, the receiver may determine a measure of the electromagnetic energy received (e.g., a measure of RSRP and/or SINR). Based on the measurements, the gNB may determine a subset of the analog beams out of the configured beams (e.g., Kᵢ beams out of Kₘₐₓ beams such that Kᵢ≤Kₘₐₓ). The WTRU may semi-statically or dynamically receive configurations and/or indications that indicates the number of select beams by the gNB (e.g., Kᵢ and the indexes of the selected beam).

Example procedures for SB-to-RBG mapping are described herein. A WTRU may receive scheduling information (e.g., an UL grant from the NW for a PUSCH transmission), where the scheduling information may indicate an SRI value that identifies an SRS resource i and a resource allocation including one or more (e.g., N_{RBG}) PUSCH resource block groups (RBGs). The grant DCI may include a Frequency Domain Resource Allocation (FDRA) which indicates the Resource Block Groups (RBGs) assigned to transmit the PUSCH, and the SRS resource index i

The WTRU may determine an association between the subbands in SRS resource i and the allocated PUSCH RBGs, for example RBG indices, (SB-to-RBG mapping) and/or a mapping between the beams associated with SRS resource i and the RBGs using one or more of the following example mappings. In an example mapping, each SRS SB of the SBᵢ SBs that overlaps an RBG, matches an RBG or a set of RBGs (in frequency). Each SB is mapped to the RBG(s) it matches in frequency (or is mapped to no RBGs in the case of no overlap). If a match is not exact, the SB that overlaps an RBG the most (e.g., the most subcarriers), is mapped to the RBG. In another example mapping, the WTRU is configured with an explicit mapping of all or a subset of the SB_i SBs or Kᵢ beams to N_{RBG} (e.g., SRS SB 1 or beam 1 maps to FDRA RBGs 1-4, etc.). In another example mapping, the WTRU is configured with a rule that is a function of the SBᵢ SBs or the Kᵢ beams and N_{RBG} (e.g., Kᵢ=2 beams and 8 RBGs; WTRU applies the first beam over the first half of the RBGs, and the second beam over the next half of RBGs). In another example mapping, the WTRU dynamically receives the mapping (e.g., SB to RBG or beam to RBG) in a DCI (e.g., the grant DCI) or a MAC-CE. The network may dynamically change the number of RBGs associated per SB or beam. When (e.g., after) the WTRU determines a SB to RBG mapping, the WTRU then maps the beam associated to each mapped SB to the RBGs mapped to the SB.

In an example, after transmitting on the first SRS resource configured with Kₘₐₓ beams, and optionally on one or more of the SRS resources configured with Kᵢ beams, the WTRU may receive a scheduling grant (e.g., CG- or DG-) to transmit a PUSCH. The WTRU may determine the RB allocation over which to transmit the PUSCH based on the Frequency Domain Resource Allocation (FDRA). The FDRA may indicate any one or more of the following information: RB Groups (RBGs), where each RBG is associated to one or more contiguous RBs; and/or the number of RBs per RBG is configured as the RBG size. Table 1 illustrates how the RBGs may be configured in 5G NR. For a given BWP size (number of RBs), there are three 3 possible configurations. Each configuration indicates the number of RBs per RBG where each RBG is located in one slot. The grant indicates the SRS resource index, i (e.g., an SRI), and the WTRU determines the Kᵢ beams associated to the PUSCH transmission as a function of the SRS resource index i. However, the WTRU does not know how to apply the beams from the SRS SBs to the RBGs.

TABLE 1
5 G NR Number of RBGs per BWP and per configuration

| Bandwidth Part Size | Configuration 1 | Configuration 2 | Configuration 3 |
|---|---|---|---|
| 1-36 | 2 | 4 | 8 |
| 37-72 | 4 | 8 | 16 |
| 73-144 | 8 | 16 | 32 |
| 145-275 | 16 | 16 | 32 |

In an example, the WTRU may transmit the PUSCH with the Kᵢ beams over the indicated RBGs, where the WTRU may determine the beam for each RBG as a function of an SB-to-RBG association/mapping. For each RBG, the SB-to-RBG may indicate the SB index from the SRS resource indicated in the grant, and may determine the beam associated to the SB index (and therefore to the RBG). In the following, SB and beam may be used interchangeably, because each SB is configured with a beam. A WTRU applying/associating/mapping a SB to an RBG may be equivalent to a WTRU applying/associating/mapping a beam to an RBG. The WTRU may determine the SB-to-RBG association/mapping in one or more of the following ways: preconfigured (e.g., RRC); or dynamically indicated (e.g., in a DCI).

In an example method for a WTRU to determine the SB-to-RBG association/mapping, each SRS resource may be configured with an SB size as a multiple of the RBG size. For example, each SB is configured as N_{StR}*RBG, where N_{StR} is the SB-to-RBG scaling factor. The N_{StR} RBGs are contiguous, and thus the WTRU may determine the SB associated to each RBG by receiving the RBG index, and looking up which SB index is associated to the RBG index. If SBs are not an integer multiple of RBGs, an RBG may overlap over more than one SB. The WTRU may apply a default rule to determine which of the SB applies for a given RBG index. For example, the WTRU may apply the SB with the lowest/highest index. In another example, different priorities may be associated or configured with the SRIs. If multiple SBs associate to the same RBG index due to the overlap, the WTRU may apply the SBs of the SRI with the highest priority (e.g., explicitly configured, or implicitly based on lowest/highest SRI value). In another example, each SRS SB of the SBᵢ SBs that overlaps an RBG, matches an RBG or a set of RBGs (in frequency). Each SB may be mapped to the RBG(s) it matches in frequency (or is mapped to no RBGs in the case of no overlap). If a match is not exact, the SB that overlaps an RBG the most (e.g., the most subcarriers), is mapped to the RBG.

In another example method for a WTRU to determine the SB-to-RBG association/mapping, the WTRU may be configured with explicit mappings of SB indices to RBG indices. The association may be one-to-one (one SB to one RBG), or one-to-many (one SB to many RBGs). The RRC configuration may be such that each RBG only associates with one SB. In an example, if the WTRU indicates a capability with more than one panel, two or more SBs may be mapped to one RBG, where each SB is associated to an SRS resource from a different panel. For example, the two SRS resources may be configured in different SRS resource sets where each set is associated to a panel. The WTRU may transmit from both panels at the same time on the same RBG with two different SB beams from the different SRS resources (E.g., SFN-like transmission).

In another example method for a WTRU to determine the SB-to-RBG association/mapping, the WTRU may derive the SB-to-RBG mapping based on a preconfigured rule as a function of the indicated SRI and RBG. A WTRU may determine to apply each beam over a function of the ratio of N_{RBG}/Kᵢ. For example, WTRU may be configured with an SRS resource with Kᵢ=2 beams and may be scheduled for PUSCH over 8 RBGs. The rule may indicate that the WTRU applies each of the SB beams from the SRS resource over N_{RBG}/Kᵢ RBGs. In an example, the WTRU may be configured to interlace the SB beams over the RBGs where interlacing applies the SB beams cyclically over the RBGs, and the pattern may repeat (e.g., with 2 beams, the interlacing pattern may be 1-2-1-2 etc., which indicates to map SB 1 to RBG 1, SB 2 to RBG 2, SB 1 to RBG 3 and so forth). A sequential mapping pattern may be configured such as 1-1-1-2-2-2 where each SB index is mapped to a sequence of RBG indices; in this example, SB index 1 is mapped to three RBG indices, and SB index 2 is mapped to the next three RBG indices.

In another example method for a WTRU to determine the SB-to-RBG association/mapping, the DCI may include a dynamic indication of the SB-to-RBG mapping along with the SRI and RBG assignment. Multiple SB-to-RBG mappings may be configured, and the indication may select one of the configured mappings based on an explicit field in the DCI. In an example, the SB-to-RBG mapping may be associated to another field in the DCI, and the WTRU may determine the SB-to-RBG mapping as a function of the value in another field in the DCI. For example, each BWP may be configured with one SB-to-RBG mapping. The DCI may dynamically switch between BWP indices by indicating the BWP index in the DCI. If the grant switches BWPs, the WTRU may determine that the applicable SB-to-RBG mapping is a function of the indicated active BWP. In an example, a WTRU may be dynamically indicated a TCI state in a DCI which maps to a source RS. Each TCI state may be configured with a SB-to-RBG mapping. When the WTRU receives a TCI state indication/activation in a DCI, the WTRU determines the applicable SB-to-RBG mapping as a function of the indicated/activated TCI state.

In an example, the SRS resource may be configured with a time-hopping period, where multiple consecutive time symbols are configured. Each symbol may be configured with a separate SB configuration and beam indices. If the SRS resource is configured with hopping, the SB-to-RBG mapping may include the SRS resource hopping index (e.g., symbol index). For example, an SRS resource may be configured with time-hopping where the first symbol is configured with two SBs and two beams (one beam per SB), and a second symbol may be configured with two SBs and two other beams (one beam per SB, different from the first symbol). The WTRU may determine the SB-to-RBG mapping as a function of the SRS resource index, and the symbol index which indicates the beams from the first or second symbol.

More than one SRI may be indicated in the DCI, and the SRS resource set indicator may indicate the WTRU to activate/apply the first or second or both SRIs. For example, in the multi-TRP scenario, the network may configure each SRI to a different TRP. The SRS resource set indicator is used to switch between sTRP operation with the first SRI, sTRP with the second SRI, and mTRP with the first and second SRI. In 5G NR, SRS resources may be explicitly associated to different TRPs through a TRP index (e.g., coresetPoolIndex). In an example, the WTRU may determine the SB-to-RBG mapping as a function of the SRS resource set indicator.

In an example, each SRS resource may be associated with one SB-to-RBG mapping. The WTRU may apply the SB-to-RBG mapping of the activated SRI. If both SRIs are activated, the WTRU may be configured with an SB-to-RBG which maps the SBs from both SRIs to the RBGs. For example, the first SB from the first SRI maps to the first RBG, and the first SB from the second SRI maps to the second RBG. The grant may also indicate the ordering of the SB-to-RBG mapping. For example, in a first ordering, the WTRU may map the lowest SB index to the lowest index of the RBG, and increase the SB index to map to the next increasing RBG index. In a second ordering, the WTRU may map the lowest SB index to the highest index of the RBG, and increase the SB index to map to the next decreasing index of the RBG. The network may switch between the two ordering to provide beam diversity over the RBGs.

In another example, the WTRU may be configured with different SB-to-RBG mapping as a function of the number of SRIs activated. For example, if either the first or second SRI is activated, the WTRU may determine to use a first SB-to-RBG mapping. If more than one SRI is activated, the WTRU may apply a second SB-to-RBG mapping where the SRIs are mapped to non-overlapping RBGs. In another example, if both SRIs are activated, the SRS indicator or a new field may switch between two different SB-to-RBG mappings, and indicate the set of RBGs associated to each SRI. For example, the first mapping may indicate to map the first SRI to half of the RBGs, and the second SRI to the other half of the SBs; the second mapping may indicate to map the first SRI to % of the RBGs, and the second SRI to the remaining RBGs. The network may use this indication to dynamically switch the number of RBGs allocated per TRP. The network may allocate more RBGs to the TRP with better channel conditions to the WTRU.

In an example, the WTRU may determine the SB-to-RBG based on the priority of the SRIs. For example, the WTRU may be indicated with a SB-to-RBG mapping that may allocate a majority of RBGs to a first SRI, and the rest to a second SRI. The WTRU may determine that the first SRI corresponds to the indicated SRI with the highest priority (e.g., lowest TRP index), and the second SRI corresponds to the indicated SRI with the lowest priority.

Procedures for PUSCH transmission with SB-based power control are disclosed herein. The WTRU may transmit the PUSCH over the allocated RBGs with the determined beam for each RBG and power control per RBG as a function of the SB-to-RBG mapping (or beam to RBG mapping). Procedures for PUSCH transmission and determination of beams with PUSCH repetitions are described hereinafter.

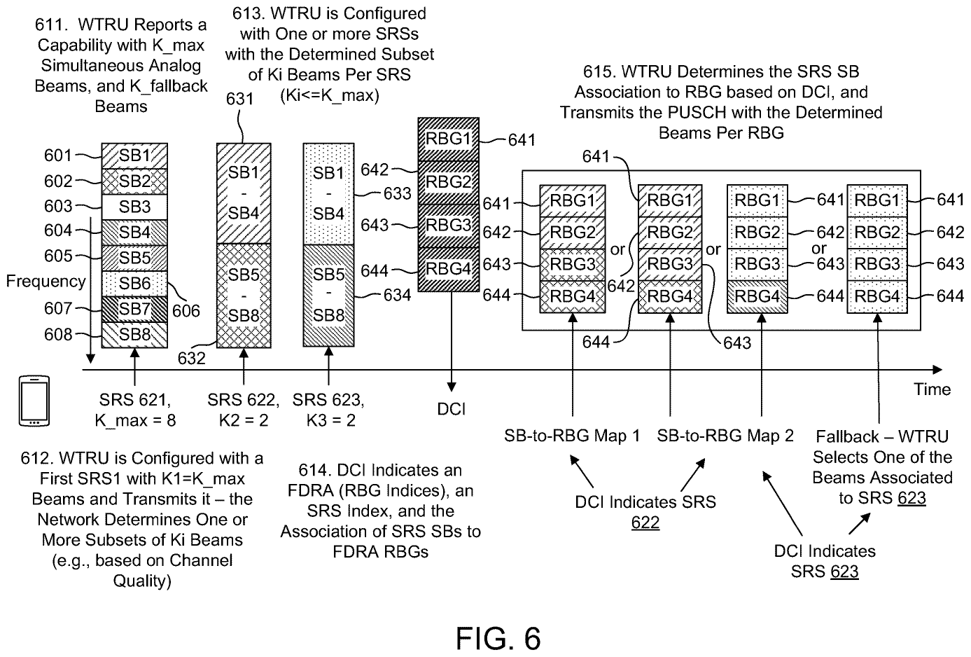

FIG. 6 is a signaling diagram illustrating an example SB-based beamforming procedure 600 using SB-to-RBG association, which may be performed by a WTRU. SB-based beamforming procedure 600 may be used for transmitting a DG-PUSCH transmission over multiple RBGs with one beam per RBG 641-644, and with different SB-to-RBG mappings indicating the beam associated to each PUSCH RBG 641-644 as a function of the SRI SBs 601-608. In FIG. 6, the distinct beams are shown by different shading patterns (e.g., stripes, dots, hash etc.). At step 611, the WTRU may report (e.g., to a NW, i.e., a base station) the WTRU's capability for the maximum number of beams that the WTRU can generate per slot, Kₘₐₓ (e.g., Kₘₐₓ=8) and/or K_{fallback}. At step 612, The NW configures the WTRU with the first SRS resource 621 with up to Kₘₐₓ beams and the SB configuration which defines the beam index per SB 601-608. The WTRU transmits SRS on the first SRS resource 621 (simultaneous transmission on SBs 601-608), and the NW receives the SRS to determine the received signal quality per SB 601-608. At step 613, based on the measurement, the NW configures SRS resources 622 and 623 with subsets of beams 631 and 632, respectively, comprising subsets of the SBs 601-608 (e.g., the number of beams for SRS resource 622 is K2=2, the number of beams for SRS resource 623 is K2=2, and SB configuration of SBs 601-604/SB1-SB4 for the first beam, and SBs 605-608/SB5-SB8 for the second beam). At step 614, the network sends to the WTRU a DCI indicating an FDRA (RBG Indices), an SRS Index, and the association of SRS SBs 601-608 to FDRA RBGs 641-644. At step 615, the WTRU determines the SRS-SB 601-608 association to RBG 641-644 based on received DCI, and transmits the PUSCH with the determined beams per RBG 641-644. Four different example SB-to-RBG mappings, where the RBG beams depend on the SRI indicated, and on the indicated association of the SB beams to the RBGs 641-644.

Example procedures described herein may use the dynamic grant (DG)-PUSCH PHY channel as an example use case. For the configured grant (CG)-PUSCH, the SB-to-RBG may be preconfigured in the CG-PUSCH. In addition, similar solutions may be applicable to the PUCCH PHY channel. A similar SB-to-RBG mapping may be applied, where the RBGs correspond to the PUCCH RB. The WTRU may use similar SB-to-RBG mappings to determine the beams per PUCCH SB. The SB-to-RBG mapping may be configured in the PUCCH resource configuration.

If the grant indicates PUSCH repetitions, the WTRU may transmit a same payload (e.g., codeword (CW), transport block size (TBS), layer, data) over multiple PUSCH resources, and the grant may indicate the PUSCH resources allocated for each PUSCH repetition index. In an example, each repetition index may be associated with its own SB-to-RBG mapping. For example, the NW may indicate to schedule the repetitions in different time and/or frequency resources. For example, the WTRU may transmit a first repetition in RBG1, and a second repetition in RBG2. Then, the WTRU may determine different beams per RBG index as a function of the associated SB-to-RBG mapping. A single SRI may be indicated in the grant and associated to multiple repetition indices.

In an example, the PUSCH resource may be configured with a time-hopping period, where multiple consecutive time symbols are configured. The WTRU may transmit each time symbol with a different beam as a function of the SB-to-RBG mapping. Each time symbol may also be associated with a different SB-to-RBG mapping. Similarly, if multiple PUSCHs are scheduled with a single grant (e.g., multi-PUSCH where each PUSCH corresponds to a different CW/TBS/layer/data), then each PUSCH index may be associated with the same or different SB-to-RBG mapping. The WTRU may use the same SB-to-RBG mapping if the FDRA of the multiple PUSCH resource is the same; if different FDRA are used (e.g., different RBGs are associated per PUSCH index), then the WTRU may determine to use a different SB-to-RBG mapping which may be indicated in the grant as a function of the SRI.

Example procedures for power control as a function of the SB configuration (SRS) and SB-to-RBG association (PUSCH) are disclosed herein. In 5G NR, the WTRU may determine a transmit power for UL signals based on a power control procedure. The WTRU may calculate a transmit power based on a pathloss measurement performed on a PL-RS. A WTRU may maintain at most four (4) pathloss estimates per serving cell for all PUSCH/PUCCH/SRS transmissions. In the case of SRS, the uplink power, P_{SRS}, is determined as

$${P}_{SRS} = min ( {P}_{Cmax} , {P}_{0}^{SRS} + 10 {log}_{10} ( {M}_{SRS} ) + α \cdot PL + {δ}_{TF} ) \qquad Eq . 1$$

where M_{SRS} may be the number of frequency resources allocated for the SRS (e.g., RBs or SBs). P_{CMAX} may be the WTRU configured maximum output power. P₀ may be a pre-configured received power target assuming full pathloss compensation. In an example, a value of a between 0 and 1 may be the fractional power control factor. A value of α=0 may mean no pathloss compensation (i.e., the WTRU may adjusts the WTRU's power independent of pathloss). A value of α=1 may mean full pathloss compensation (i.e., the WTRU may adjust the WTRU's power to completely cancel out the pathloss). STF may be a closed loop power control component that allows base station to adjust the transmit power at WTRU. The above may be based on Transmit Power Control (TPC) command from Downlink Control Information (DCI) on the PDCCH.

In an example, to support the simultaneous beams per time resource, a WTRU may be configured with different a and/or δ_{TF} for each beam. For example, if a WTRU is configured with Kᵢ beams, a WTRU may be configured with αₙ for each sub-band where 1≤n≤N_{Subband} and

$${δ}_{TF}^{n}$$

for each subband where 1≤i≤N_{subband}; in this case, the uplink power control for SRS changes to the following formula:

$${P}_{SRS}^{n} = min ( {P}_{Cmax}^{n} , {P}_{0}^{SRS ′} + 10 {log}_{10} ( {M}_{SRS} ) + {α}_{n} \cdot PL + {δ}_{TF}^{n} ) \qquad Eq . 2$$

$$1 \leq n \leq {N}_{Subband}$$

The value of αₙ and

$${δ}_{TF}^{n}$$

may be configured based on the WTRU may be configured with different pathloss for each subband. The WTRU may be configured or determine a

$${P}_{Cmax}^{n}$$

per SB where

$${P}_{Cmax}^{n}$$

may be determined for example based on the value of N_{Subband} (e.g., P_{Cmax} equally split amongst N_{Subband}, or allocated such that the linear combination of

$${P}_{Cmax}^{n}$$

over all n sums up to P_{Cmax}). In an example, the WTRU may determine the power as

$${P}_{SRS} = min ( {P}_{Cmax} , {\sum }_{n} {P}_{0} + 10 {log}_{10} ( {M}_{SRS}^{n} ) + {α}_{n} \cdot {PL}^{n} + {δ}_{TF}^{n} ) .$$

In this case, the WTRU may determine the overall power using a single P_{CMAX} defined for the entire bandwidth, and the may adjust the power per SB based on the beam per SB. Each SB may be associated with its own parameters (e.g., pathloss (PL), alpha, delta).

Similarly for PUSCH, the uplink power control may be determined based on

$${P}_{PUSCH , b , f , c} ( i , j , {q}_{d} , l ) = min \{ \begin{matrix}{P}_{CMAX , f , c} ( i ) \\ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} \qquad Eq . 3$$

$$[ dBm ]$$

For PUSCH, the power control parameters may depend on the SB-to-RBG mapping, because the WTRU may receive the FDRA on different RBGs, and the WTRU may first determine the beam (e.g., SB from the SRI) associated to the RBG to determine the pathloss and power to adjust. For example, PUSCH power control depends on the FD resource allocation,

$${M}_{RB , b , f , c}^{PUSCH} ,$$

as a function of the SB-to-RBG mapping. PL_{b,f,c}(q_{d}), PL reference signal, and f_{b,f,c}(i,l), CL TPC, also depend on the SB-to-RBG mapping.

In an example, to support the simultaneous beams per time resource, similar solutions to the SRS PUSCH power control may be configured, where a P_{CMAX} and associated parameters may be defined per SB, and the WTRU may choose the parameters as a function of the RBGs, SRI and SB-to-RBG association from the grant. For example, the WTRU may derive the power per SB as a function of the per SB power control parameters, where the WTRU determines

$${P}_{PUSCH}^{{RBG}_{n}} = min ( {P}_{Cmax}^{{RBG}_{n}} , {P}_{O \_ PUSCH , b , f , c} ( j ) + 10 {log}_{10} ( {2}^{μ} \cdot {M}_{RB , b , f , c}^{PUSCH , {RBG}_{n}} ( i ) ) + {α}_{b , f , c}^{{RBG}_{n}} ( j ) \cdot {PL}_{b , f , c}^{{RBG}_{n}} ( {q}_{d} ) + {Δ}_{TF , b , f , c}^{{RBG}_{n}} ( i ) + {f}_{b , f , c}^{{RBG}_{n}} ( i , l ) ) \qquad Eq . 4$$

where RBGₙ may be the number of RBs associated to SB n from the SRI indicated in the grant.

The WTRU may determine RBGₙ using the SB-to-RBG association. Then, the WTRU may determine the power control parameters associated to the SRI for the n^{th} SB, apply it to the RBGₙ. In this case, separate P_{CMAX} values may be considered per RBG. In an example, a single P_{CMAX} value may be configured for the power control process, and the WTRU may determine an overall power control for the entire grant as a function of per RBG assignment. For example,

$${P}_{PUSCH , b , f , c} ( i , j , {q}_{d} , l ) = min \{ {\sum }_{{RBG}_{n}} \begin{matrix}{P}_{CMAX , f , c} ( i ) \\ {P}_{{O}_{PUSCH , b , f , c}} ( j ) + 10 {log}_{10} ( {2}^{μ} \cdot {M}_{RB , b , f , c}^{PUSCH , {RBG}_{n}} ( i ) ) + … \\ {α}_{b , f , c}^{{RBG}_{n}} ( j ) \cdot {PL}_{b , f , c}^{{RBG}_{n}} ( {q}_{d} ) + {Δ}_{TF , b , f , c}^{{RBG}_{n}} ( i ) + {f}_{b , f , c}^{{RBG}_{n}} ( i , l )\end{matrix} \} \qquad Eq . 5$$

A WTRU may be configured with different TPMI for each subband where applied precoding for PUSCH may be different for each subband. The flexibility of

$${M}_{RB , b , f , c , k}^{PUSCH} ,$$

PL_{b,f,c,k}(q_{d}) and f_{b,f,c,k}(i, l) for each subband may be taken into consideration based on power of each precoding. For example, precoding matrix W0 corresponding to TPMI=0 for single-layer transmission using four antenna ports with transform precoding disabled is [0.5 0 0 0] and W12 corresponding to TPMI=12 for single-layer transmission using four antenna ports with transform precoding disabled is [0.5 0.5 0.5 0.5]. Thus, W12 provides more power for the corresponding subband than W0. In view of this, to adjust

$${M}_{RB , b , f , c , k}^{PUSCH} ,$$

PL_{b,f,c,k}(q_{d}) and f_{b,f,c,k}(i, l) for each subband, TPMI selection should be taken into consideration.

Example procedures for maximum power reduction (MPR) and power headroom report (PHR) determination per SB as a function of the SB-to-RBG association are disclosed herein. Because each SB from the SRS is transmitted with a different beam, the SB-to-RBG mapping may lead to differences in power levels and capability between the different SB beams.

For example, as illustrated in FIG. 2, if the WTRU reports it is capable of Kₘₐₓ=8 beams over 8 SBs, then the SRS covering the wide channel (e.g., the first SRS over all SBs) may be transmitted in all (8) analog beams for initial probing of the channel. SRS has a very low MPR and thus the SRS power density has a maximum headroom. However, when a PUSCH is to be transmitted, a different modulation may be used and then the MPR level may be different across the channel. 3GPP may define a Maximum Power Reduction (MPR) that the WTRU may use to reduce the WTRU's maximum transmit power as a function of the modulation order (e.g., high order QAM) and configured bandwidth. The WTRU may use the MPR when the WTRU's transmit power exceeds the Maximum Permissible Exposure (MPE) (i.e., if the radiated power output is above a threshold). Different MPR values may be used as a function of the RBG allocated for PUSCH transmission depending on their relative location to the frequency band. For example, 3GPP defines different MPR values depending on whether the RBGs are allocated on the edge, outer, or inner band. For example, the center channel SBs may have a substantial lower MPR than channel edge SBs. Thus, the related P_{CMAX} and related SBs or SB group (SBG) PHR may be different.

TABLE 2
SB grouping and their MPR values

| | | | | | | | |
|---|---|---|---|---|---|---|---|
| SB0 | SB1 | SB2 | SB3 | SB4 | SB5 | SB6 | SB7 |

| | | | |
|---|---|---|---|
| SBG0 | SBG1 | SBG2 | SBG3 |
| MPR1 | MPR2 | MPR2 | MPR1 |

For example, in Table 2, one such table may be configured with different MPR values associated to SB or SBG configured for the SRS. The MPR2 corresponding to SBG1 and SBG2 is lower than MPR1 corresponding to SBG0 and SBG3 which may be configured as a function of the SB locations. For example, SBG0 may be configured for SBs on the edge of the BWP, SBG1 for the SBs on the outer, etc. The location or indices of the edge/outer/inner SBs may be explicitly configured and associated to SBGs.

In addition to the regular power control procedure for SRS and PUSCH, the WTRU may report the MPR together with a Power Headroom Report (PHR). The PHR may be valid for a PUSCH or SRS transmission occasion. The WTRU may determine the PH as the difference between a calculated power and a maximum power, P_{CMAX}. The calculated power may be for example the power determined by the WTRU based on power control for PUSCH or SRS. The PH thus may indicate how much power the WTRU has left over after allocating the WTRU's power for a PUSCH or SRS transmission (e.g., Type 1, Type 2, Type 3 PHR). The PH may be a function of a frequency allocation (e.g., FDRA in a grant), or it may be calculated based on a reference format (e.g., assuming a fixed RB allocation if there is no grant). The PH may be a function of the pathloss (PL) that the WTRU measures based on a PL-RS (e.g., CSI-RS or SSB). If the WTRU calculates a PHR or MPR for SRS, the PL-RS may be configured together with the SRS (e.g., associated with SRI).

A power headroom report (PHR) may include PH information for one or more cells. PH information may, for example, include at least one of: a PH (e.g., a PH value); a maximum power (e.g., P_{CMAX,c} or P_{CMAX,c}); an indication of whether the PH value is real or virtual (e.g., V flag/indicator); a flag or indicator (e.g., P or other flag/indicator) indicating whether a power backoff (e.g., a power management power backoff or power reduction) is affecting the maximum power; and/or a flag or indicator (e.g., P or other flag/indicator) indicating whether an applied power backoff such as P-MPR is less than (or greater than or equal to) a configured, specified or otherwise known value such as a value to meet maximum permissible exposure (MPE) requirements.

The PHR may be triggered based on one or more conditions being satisfied. Such conditions may include at least one of: expiry of a timer (e.g., a periodic timer); a PL value (e.g., for a cell or TRP) has changed by more than a threshold (e.g., since the last time a PHR was transmitted); a power backoff such as a power backoff due to power management (e.g., as allowed by P-MPR) has changed by more than a threshold; and/or a P-MPR (e.g., a measured P-MPR) such as a P-MPR applied to meet MPE requirements is or has changed to be equal to or larger than a threshold (e.g., since the last time PHR was transmitted).

For PHR for SB-based PUSCH, in an example, the PHR may be reported simultaneously for SB individually or SB groups (SBG) across the channel. A WTRU may include more than one PH or MPR values in a single PHR where each PH or MPR value may be associated to a SB or SBG. The index of the SB or SBG that are triggered to be reported may be a function of the SB-to-RBG mapping. The WTRU may receive a PUSCH grant with the RBG indices, and the WTRU may determine the SB-to-RBG mapping to determine which SB or SBGs PH and/or MPR values should be included in the PHR. For example, when the PHR is reported for a real UL PUSCH in a SB or SB group that is allocated (e.g., real PHR for allocated SBs), the WTRU may report a separate virtual PHR for the same modulation in all other SB or SB groups (e.g., virtual PHR for non-allocated SBs). The WTRU may calculate and report the PHR for the real PUSCH, and may explicitly indicate it and then differential values relative to the real one for the rest of the SBGs as virtual PHR on the same modulation assumption. The PHR SB or SB grouping may be configured or indicated to the WTRU following the WTRU's reported capability of Kₘₐₓ and SB UL beams. In an example, if WTRU is indicated to perform SB hopping (e.g., SB1 in slot 1 and SB2 in slot 2), the WTRU may indicate the SB PHRs and P_{CMAX} associated to all SBs or SBGs in the hopping pattern.

In an example of PHR for SB-based SRS, for the Type 3 PHR, related to the SRS transmission, the equation to determine the PH value may be

$${PH}_{type 3 , b , f , c} ( i , {q}_{s} ) = {P}_{CMAX , f , c} ( i ) - \{ {P}_{{O}_{SRS} , b , f , c} ( {q}_{s} ) + 10 log 10 ( {2}^{u} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i ) \} \qquad Eq . 6$$

The WTRU may report the PH related to the number of beams/SBs used for SRS. For example, in Eq. 6, the values of M_{SR}s and PL refer to the number of SBs and pathloss value configured with the SRI. Because a single beam is used, the WTRU may only require a single M_{SR}s and PL value per SRS. However, with the SB-based beams per SRS, the WTRU may report one PH value per SB where each PH value is associated with its own M_{SR}s and PL value. The WTRU may determine the PL value (e.g., PL-RS) as a function of the SB or SBG index associated to the M_{SR}s allocation. In an example, if the SRS configured bandwidth is smaller than a SB, the WTRU may report a single value that may be interpreted by the base station as a corresponding power density in that SB that would be similar to any other SB on the WTRU side with the same bandwidth.

In another example, if the WTRU may transmit an SRS that is spread across the channel in all SBs (and thus all beams), then the WTRU may report a global PHR covering all SBs, meaning a full channel power density related PHR, or a total power density per SB according to the P_{CMAX} that would be available for the corresponding SB. In an example, the WTRU may report an SB based PHR by scaling the power accordingly per SB or SBG. The WTRU may determine the scaling factor per SB or SBG in order to achieve a total power that does not exceed P_{CMAX}. The SB or SBG PHR reports may be configured by the base station. For example, if M_{SRS,b,f,c}(i)≤SB, then the PH type 3 may be carrying the SB index and may indicate the SB related PHR, while the rest of the parameters may have the same significance. If the M_{SRS,b,f,c}(i)≤SBG, meaning the SRS allocation covers an SBG (a subset of SBs), then a supplementary index may be assigned for the SBG, or the PHR may be reported per SB by splitting the M_{SRS,b,f,c}(i) and scaling the power over the allocated SBs and the SB index may be added to the PHR equation.

Example procedures for fallback operation with SB-based analog beamforming are disclosed herein. In an example, in fallback mode, the WTRU may select K_{fallback} beams out of the Kᵢ indicated beams, and may determine the association of K_{fallback} beams to the RBGs. The WTRU may determine that it's in fallback mode based on a condition to switch between one or more of SB-/non-SB-based beamforming with K_{fallback} beams. In an example, the fallback mode determination may be based one or more of the following rules. An example rule may include if a number of scheduled RBGs/BWP size is below a threshold, there is no always-on SSB (e.g., on-demand SSB only; WTRU selects subset K_{fallback} associated to the activated SSBs); time elapsed since last SRS transmission of Kᵢ beams; WTRU's inactivity timer WTRU exceeds P_{CMAX} with Kᵢ beams PUCCH is overlapped with PUSCH (e.g., PUCCH transmitted on a different SB from PUSCH; WTRU prioritizes the PUCCH beam in its selection). Another example rule may be based on an explicit fallback indication (e.g., WTRU-initiated or NW-indicated power saving mode, dynamic switching of PUSCH resource allocation mode). The WTRU may dynamically indicate the index of the selected K_{fallback} out of the Kᵢ beams when switching to energy savings mode. The WTRU apply the SB-to-RBG mapping based on the determined fallback mode (e.g., a default SB-to-RBG mapping, or prioritized selection of K_{fallback} indices out of Kᵢ).

In an example, the WTRU may (be configured to) determine whether to apply a fallback mode from (e.g., instead of, switched from, temporarily from) using the Kᵢ beams over indicated RBGs (e.g., for a scheduled UL transmission such as PUSCH transmission). Determining to apply a fallback mode may be based on at least one of following conditions. According to an example condition, the WTRU reported the WTRU's capability on the fallback number of simultaneous analog beams, K_{fallback} (<=Kₘₐₓ) and/or the WTRU receives a confirmed number of simultaneous analog beams (e.g., the same value as K_{fallback} or an adjusted value as K_{fallback,adjusted}, such as <K_{fallback} for example) when the fallback mode is applied. According to another example condition, a number of scheduled RBGs/BWP size may be below a threshold, where the threshold may be configured or indicated. According to another example condition, when the WTRU determines there is no always-on SSB to be transmitted (or there is on-demand SSB (only) to be transmitted) within a pre-defined or pre-configured time-duration, where the time-duration may be determined based on one or more configured parameters such as at least one of a starting time unit (e.g., slot or symbol), a length of the time-duration, an ending time unit, a timer, and/or an elapsing condition of the timer, and so on.

According to another example condition, on condition that the WTRU determines a time-related parameter (e.g., being configured or pre-defined) elapsed since last SRS transmission of Kᵢ beams. According to another example condition, based on the WTRU's inactivity timer, for example when the WTRU determines (e.g., declares) that there have been no active communications such as DL receptions and/or UL transmissions during a time window based on the WTRU's inactivity timer (e.g., when it has elapsed). According to another example condition, based on power-domain condition(s), such as when the WTRU determines the current (power-controlled) UL Tx power level (e.g., for the scheduled UL transmission based on the Kᵢ beams) exceeds a maximum allowed Tx power level (e.g., based on the configured parameter of P_{CMAX}, with Kᵢ beams). According to another example condition, based on at least one resource overlapping condition (among multiple UL channels or signals such as PUSCH, PUCCH, SRS, PRACH, DMRS, PTRS), for example when a PUCCH is overlapped with the scheduled PUSCH. In an example, the PUCCH to be transmitted on a different SB may have a time-domain overlap with the scheduled PUSCH, and the WTRU may be configured or indicated to prioritize the PUCCH beam in the WTRU's selection.

According to another example condition, based on receiving at least one explicit signaling indicating to apply the fallback mode, such as a WTRU-initiated or NW-indicated power saving mode, dynamic switching of PUSCH resource allocation mode, etc. In an example, the network indication may relate to a network energy saving operation. This indication may include a set of new beams which are available in NW energy saving mode, or times in which beams are (un)available. The WTRU may adjust the fallback mode according to the beams available and/or duration of network energy saving.

In an example, based on the determination to apply the fallback mode, the WTRU may perform at least one of following behaviors for transmitting a UL channel or signal (e.g., the scheduled PUSCH originally scheduled based on using the Kᵢ beams over indicated RBGs), which may be based on examples of FIG. 6. According to an example behavior, the WTRU may select K_{fallback} (or K_{fallback,adjusted}) beams out of the Kᵢ indicated beams, and determine the association of K_{fallback} (or K_{fallback,adjusted}) beams to the RBGs. According to another example behavior, the WTRU may select a subset K_{fallback} (or K_{fallback,adjusted}) associated to the activated SSBs, for example when there exists on-demand SSB (only), and/or for example within the pre-defined or pre-configured time-duration.

According to another example behavior, the WTRU may dynamically indicate (or be indicated with) the index of the selected K_{fallback} (or K_{fallback,adjusted}) out of the Kᵢ beams when switching to energy savings mode (e.g., power saving mode). According to another example behavior, the WTRU may apply the SB-to-RBG mapping based on the determined fallback mode (e.g., a default SB-to-RBG mapping, or a prioritized selection of K_{fallback} (or K_{fallback,adjusted}) indices out of Kᵢ). According to another example behavior, the WTRU may apply (e.g., based on an implicit or explicit indication) at least one of pre-defined or pre-configured fallback UL transmission schemes such as a SB-based UL Tx scheme with K_{fallback} (or K_{fallback,adjusted}) beams, a non-SB-based operation (e.g., based on using a single (analog) beam), and/or an open-loop SB-based scheme with beam cycling.

In an example, at least one of the K_{fallback} (or K_{fallback,adjusted}) beam(s) may be applied across the whole RBGs based on the scheduled UL channel or signal (e.g., PUSCH). As illustrated in FIG. 6, the WTRU may apply a first beam of the K_{fallback} (or K_{fallback,adjusted}) beams, which is supposed to apply to RBG1, 2, 3 (RBG 641, 642, 643) before applying the fallback mode, to apply the whole (or a subset of the whole) scheduled RBGs which may be RBG1, 2, 3, and 4 (RBG 641, 642, 643, 644). This may provide benefits in terms of improving robustness (e.g., for such UL transmissions) by using down-selected K_{fallback} (or K_{fallback,adjusted}) beam(s) instead of Kᵢ beams, based on the determined condition(s) enabling the fallback mode.

When the open-loop SB-based scheme with beam cycling is selected or enabled, the WTRU may use a set of beams (e.g., Kᵢ beams, K_{fallback} beams, or K_{fallback,adjusted} beams) across the scheduled RBGs in a beam cycling pattern (being pre-defined or pre-configured or indicated). In an example, the WTRU may apply a first beam (of the set) to RBG1, a second beam (of the set) to RBG2, the first beam (of the set) to RBG3, and the second beam (of the set) to RBG4, e.g., on condition that the number of beams in the set is two. In an example, the WTRU may apply a first beam (of the set) to RBG1, a second beam (of the set) to RBG2, a third beam (of the set) to RBG3, and the first beam (of the set) to RBG4, e.g., on condition that the number of beams in the set is three. In an example, the next UL transmission occasion (e.g., for the same type of UL transmission such as a PUSCH), the WTRU may apply the second beam (of the set) to RBG1 (e.g., because the first beam was used in the last RBG4 of the previous Tx occasion), the third beam (of the set) to RBG2, the first beam (of the set) to RBG3, and the second beam (of the set) to RBG4, and so on.

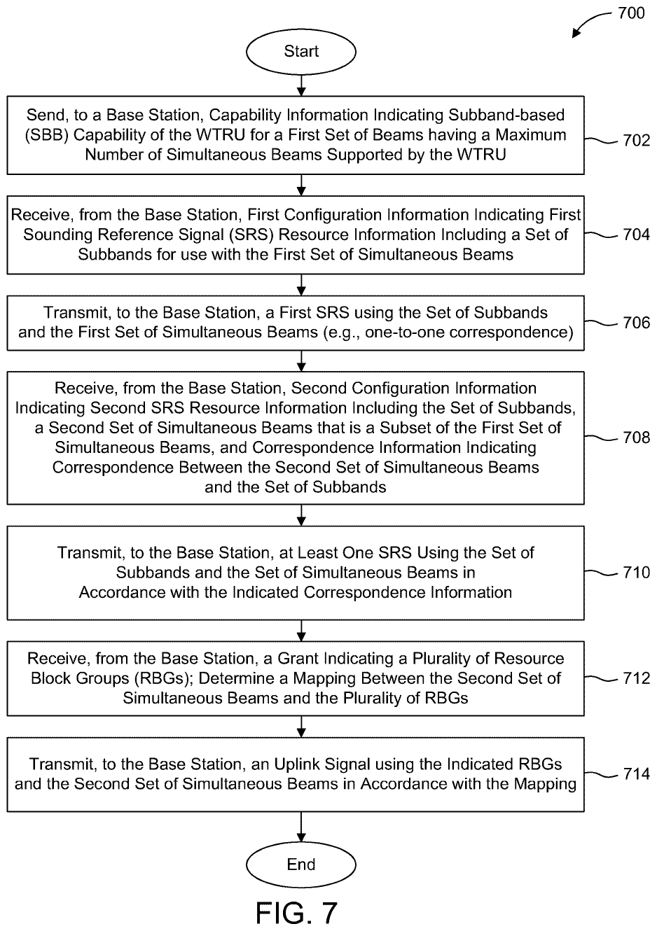

FIG. 7 is a flow diagram illustrating an example uplink transmission procedure 700 with SB-based beamforming SB-to-RBG association, which may be performed by a WTRU. At 702, a WTRU may send, to a base station, capability information indicating subband-based (SBB) capability of the WTRU for a first set of beams having a maximum number of simultaneous beams supported by the WTRU. At 704, the WTRU may receive, from the base station, first configuration information indicating first sounding reference signal (SRS) resource information including a set of subbands for use with the first set of simultaneous beams. At 706, the WTRU may transmit, to the base station, a first SRS using the set of subbands and the first set of simultaneous beams (e.g., one-to-one correspondence between the set of subbands and the first set of simultaneous beams). At 708, the WTRU may receive, from the base station, second configuration information indicating second SRS resource information including the set of subbands, a second set of simultaneous beams that is a subset of the first set of simultaneous beams, and correspondence information indicating correspondence between the second set of simultaneous beams and the set of subbands. At 710, the WTRU may transmit, to the base station, at least one SRS using the set of subbands and the set of simultaneous beams in accordance with the indicated correspondence information. At 712, the WTRU may receive, from the base station, a grant indicating a plurality of resource block groups (RBGs); and determine a mapping between the second set of simultaneous beams and the plurality of RBGs. At 714, the WTRU may transmit, to the base station, an uplink signal using the indicated RBGs and the second set of simultaneous beams in accordance with the mapping.

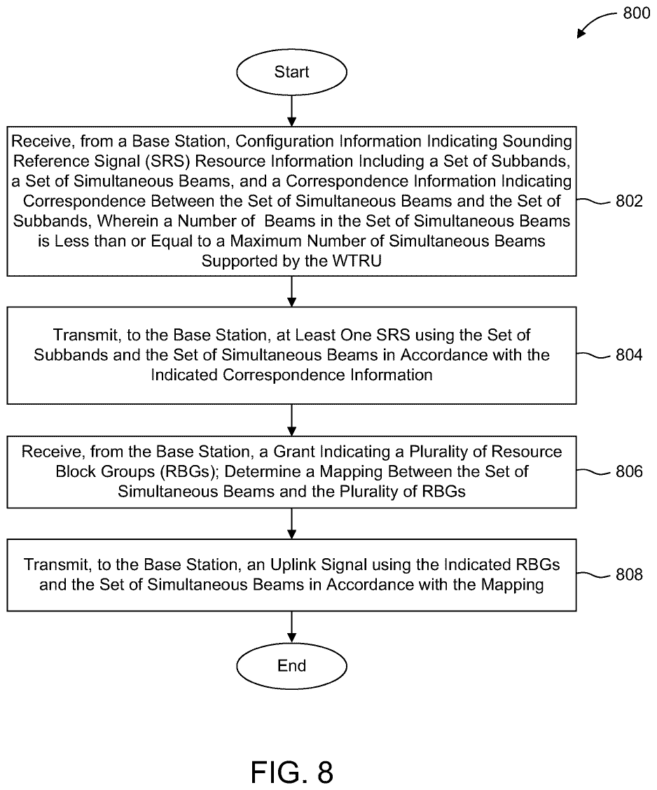

FIG. 8 is a flow diagram illustrating another example uplink transmission procedure 800 with SB-based beamforming SB-to-RBG association, which may be performed by a WTRU. At 802, the WTRU may receive, from a base station, configuration information indicating sounding reference signal (SRS) resource information including a set of subbands, a set of simultaneous beams, and correspondence information indicating correspondence between the set of simultaneous beams and the set of subbands, wherein a number of beams in the set of simultaneous beams is less than or equal to a maximum number of simultaneous beams supported by the WTRU. At 804, the WTRU may transmit, to the base station, at least one SRS using the set of subbands and the set of simultaneous beams in accordance with the indicated correspondence information. At 806, the WTRU may receive, from the base station, a grant indicating a plurality of resource block groups (RBGs). The WTRU may determine a mapping between the set of simultaneous beams and the plurality of RBGs. At 808, the WTRU may transmit, to the base station, an uplink signal using the indicated RBGs and the set of simultaneous beams in accordance with the mapping.

In an example, at least one beam in the set of simultaneous beams corresponds to two or more subbands in the set of subbands. In an example, the grant is received in downlink control information (DCI). In an example, the uplink signal is a physical uplink shared channel (PUSCH) transmission. In an example, the received configuration information may further indicate a second SRS resource information including the set of subbands, a second set of simultaneous beams, and a second correspondence information indicating correspondence between the second set of simultaneous beams and the set of subbands, where a number of beams in the second set of simultaneous beams is less than or equal to the maximum number of simultaneous beams supported by the WTRU. In an example, the WTRU may further transmit, to the base station, capability information indicating subband-based (SBB) capability of the WTRU for a set of all beams supported by the WTRU. In an example, the WTRU may further receive, from the base station, second configuration information indicating a second SRS resource information including the set of subbands and a second set of simultaneous beams that includes all beams supported by the WTRU. In an example, the WTRU may further transmit, to the base station, a second SRS using the set of subbands of the second SRS resource and the second set of simultaneous beams in accordance with the second configuration information. In an example, the mapping between the set of simultaneous beams and the plurality of RBGs maps indicates a beam of the set of simultaneous beams mapped to an RBG of the plurality of RBGs for which a subband corresponding to the beam overlaps in frequency with the RBG of the plurality of RBGs. In an example, the mapping between the set of simultaneous beams and the plurality of RBGs is an explicit mapping of one or more of the set of simultaneous beams or subbands associated with the set of simultaneous beams to the plurality of RBGs. In an example, the mapping between the set of simultaneous beams and the plurality of RBGs is based on a rule that is a function of the set of simultaneous beams or subbands associated with the set of simultaneous beams and the plurality of RBGs. In an example, the mapping between the set of simultaneous beams and the plurality of RBGs is received from the base station.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a transceiver; and
a processor, wherein the transceiver and the processor are configured to:
receive, from a base station, configuration information indicating sounding reference signal (SRS) resource information including a set of subbands, a set of simultaneous beams, and correspondence information indicating correspondence between the set of simultaneous beams and the set of subbands, wherein a number of beams in the set of simultaneous beams is less than or equal to a maximum number of simultaneous beams supported by the WTRU;
transmit, to the base station, at least one SRS using the set of subbands and the set of simultaneous beams in accordance with the indicated correspondence information;
receive, from the base station, a grant indicating a plurality of resource block groups (RBGs);
determine a mapping between the set of simultaneous beams and the plurality of RBGs; and
transmit, to the base station, an uplink signal using the indicated RBGs and the set of simultaneous beams in accordance with the mapping.

2. The WTRU of claim 1, wherein at least one beam in the set of simultaneous beams corresponds to two or more subbands in the set of subbands.

3. The WTRU of claim 1, wherein the grant is received in downlink control information (DCI).

4. The WTRU of claim 1, wherein the uplink signal is a physical uplink shared channel (PUSCH) transmission.

5. The WTRU of claim 1, wherein the received configuration information further indicates second SRS resource information including the set of subbands, a second set of simultaneous beams, and second correspondence information indicating correspondence between the second set of simultaneous beams and the set of subbands, wherein a number of beams in the second set of simultaneous beams is less than or equal to the maximum number of simultaneous beams supported by the WTRU.

6. The WTRU of claim 1, wherein the transceiver and the processor are further configured to:
transmit, to the base station, capability information indicating subband-based (SBB) capability of the WTRU for a set of all beams supported by the WTRU;
receive, from the base station, second configuration information indicating second SRS resource information including the set of subbands and a second set of simultaneous beams that includes all beams supported by the WTRU; and
transmit, to the base station, a second SRS using the set of subbands and the second set of simultaneous beams in accordance with the second configuration information.

7. The WTRU of claim 1, wherein the mapping between the set of simultaneous beams and the plurality of RBGs indicates a beam of the set of simultaneous beams mapped to an RBG of the plurality of RBGs for which a subband corresponding to the beam overlaps in frequency with the RBG of the plurality of RBGs.

8. The WTRU of claim 1, wherein the mapping between the set of simultaneous beams and the plurality of RBGs is an explicit mapping of one or more of the set of simultaneous beams or subbands associated with the set of simultaneous beams to the plurality of RBGs.

9. The WTRU of claim 1, wherein the mapping between the set of simultaneous beams and the plurality of RBGs is based on a rule that is a function of the set of simultaneous beams or subbands associated with the set of simultaneous beams and the plurality of RBGs.

10. The WTRU of claim 1, wherein the mapping between the set of simultaneous beams and the plurality of RBGs is received from the base station.

11. A method performed by a wireless transmit/receive unit (WTRU), the method comprising:
receiving, from a base station, configuration information indicating sounding reference signal (SRS) resource information including a set of subbands, a set of simultaneous beams, and correspondence information indicating correspondence between the set of simultaneous beams and the set of subbands, wherein a number of beams in the set of simultaneous beams is less than or equal to a maximum number of simultaneous beams supported by the WTRU;
transmitting, to the base station, at least one SRS using the set of subbands and the set of simultaneous beams in accordance with the indicated correspondence information;
receiving, from the base station, a grant indicating a plurality of resource block groups (RBGs);
determining a mapping between the set of simultaneous beams and the plurality of RBGs; and
transmitting, to the base station, an uplink signal using the indicated RBGs and the set of simultaneous beams in accordance with the mapping.

12. The method of claim 11, wherein at least one beam in the set of simultaneous beams corresponds to two or more subbands in the set of subbands.

13. The method of claim 11, wherein the grant is received in downlink control information (DCI).

14. The method of claim 11, wherein the uplink signal is a physical uplink shared channel (PUSCH) transmission.

15. The method of claim 11, wherein the received configuration information further indicates second SRS resource information including the set of subbands, a second set of simultaneous beams, and second correspondence information indicating correspondence between the second set of simultaneous beams and the set of subbands, wherein a number of beams in the second set of simultaneous beams is less than or equal to the maximum number of simultaneous beams supported by the WTRU.

16. The method of claim 11, further comprising:
transmitting, to the base station, capability information indicating subband-based (SBB) capability of the WTRU for a set of all beams supported by the WTRU;
receiving, from the base station, second configuration information indicating second SRS resource information including the set of subbands and a second set of simultaneous beams that includes all beams supported by the WTRU; and
transmitting, to the base station, a second SRS using the set of subbands and the second set of simultaneous beams in accordance with the second configuration information.

17. The method of claim 11, wherein the mapping between the set of simultaneous beams and the plurality of RBGs indicates a beam of the set of simultaneous beams mapped to an RBG of the plurality of RBGs for which a subband corresponding to the beam overlaps in frequency with the RBG of the plurality of RBGs.

18. The method of claim 11, wherein the mapping between the set of simultaneous beams and the plurality of RBGs is an explicit mapping of one or more of the set of simultaneous beams or subbands associated with the set of simultaneous beams to the plurality of RBGs.

19. The method of claim 11, wherein the mapping between the set of simultaneous beams and the plurality of RBGs is based on a rule that is a function of the set of simultaneous beams or subbands associated with the set of simultaneous beams and the plurality of RBGs.

20. The method of claim 11, wherein the mapping between the set of simultaneous beams and the plurality of RBGs is received from the base station.
